(19) United States
(12) Patent Application Publication
(10) Pub. No.: US 2003/0148042 A1
(43) Pub. Date: Aug. 7, 2003

(54) Ultrasonic method for the production of inorganic/organic hybrid nanocomposite

(76) Inventor: Zhikai Wang, Roswell, GA (US)

Correspondence Address: WENDEROTH, LIND & PONACK, L.L.P., 2033 K STREET N. W., SUITE 800, WASHINGTON, DC, 20006-1021, US

(21) Appl. No.: 10/028,735

(22) Filed: Dec. 28, 2001

(51) Int. Cl. B05D 7/00

(52) U.S. Cl. 427/601; 427/212

(57) ABSTRACT

The present invention provides a method for producing organic/inorganic hybrid nanocomposites by use of ultrasonic agitation.

### BACKGROUND OF INVENTION AND PRIOR ART

1. Field of the Invention

The present invention relates to a method for fabricating nanocomposite, particularly, organic-inorganic hybrid nanocomposite and nanocomposites produced thereby.

In the present method, the combination of ultrasonic irradiation and surface modification/functionalization of nanoparticles is, for the first time, employed for producing nanocomposite.

2. Prior Art Related to the Invention

Ultrasonic irradiation has been very well recognized as one of energy sources used by chemists for a long time. Ultrasonic irradiation differs from traditional energy sources, such as heat, light, or ionizing radiation, in duration, pressure, and many other aspects. The chemical effects of ultrasound do not come from a direct interaction with molecular species. Instead, it principally derives from acoustic cavitation: the formation, growth, and implosive collapse of numerous bubbles in a liquid. Acoustic cavitation serves as a means of concentrating the diffuse energy of sound. Bubble collapse induced by the cavitation produces short-lived, but intense local heating (hot spots) and high-pressure spots (Suslick et al., J. Am. Chem. Soc. 108, 5641 (1986)). In heterogeneous liquid-solid systems, cavitation near extended liquid-solid interface is very different from the cavitation in pure liquids. Two mechanisms are proposed for the effects of cavitation near the surface of solids: microjet impact (Lauterborn et al., 16, 223, (1984)) and shock wave damage (Doktycz et al., Science 247, 1067 (1990)). According to Lauterborn supra, the asymmetry of the environment near the interface induces a deformation of the cavity during its collapse. This deformation is self-reinforcing, and it sends a fast-moving stream of liquid though the cavity at the surface with velocities greater than 100 m/s. The second mechanism of cavitation-induced surface damage invokes shock waves created by cavity collapse in the liquid (Doktycz supra). The shock waves created by homogeneous cavitation can create high-velocity interparticle collisions. The impingement of microjets and/or shock waves on the surface creates the localized erosion responsible for ultrasonic cleaning and many of the sonochemical effects on heterogeneous reaction (Suslick, Science 3, 1439 (1990)).

In summary, ultrasonic energy can be principally employed for dispersing, crushing/pulverizing, freshening (cleaning) particles, and in some cases, activating surfaces of particles, as well as initiating some chemical reactions.

Practically, ultrasonic irradiation has been widely used for vessel cleaning in both scientific laboratories and industries.

Ultrasonic irradiation has also been widely used as an energy source for dispersing pigments and/or particles, including nanoparticles, into immiscible media in both scientific laboratories and industries. This application has resulted in a number of patents, including DE 2656330 (1976), DE 2842232 (1978), EP 308600 (1987), EP 308933 (1988), EP 434980 (1989), WO 92/00342 (1990), DE 4328088 (1993), and EP 434980 (U.S. Pat. No. 5,122,047). In these applications, surfactants (dispersants) are usually used for purposes of reducing particle surface energy, and later particle surface protection, therefore stabilizing the produced dispersion/suspension. Without the surface protection, the dispersed particles, particularly the nanoparticles, would unavoidably re-agglomerate in some degree due to their extremely high surface energy. However, very often, these surfactants were unwanted, sometimes even considered as contaminated materials for the end applications.

The use of high intensity ultrasound to enhance the reactivity of metals as stoichiometric reagents in many heterogeneous organic and organometallic reactions has attracted more and more attention (Suslick, Adv. Organomet. Chem. 25, 73 (1986); Lindley et al., Chem. Soc. Rev. 16, 239,275 (1987); Suslick, “Ultrasound: Its Chemical, Physical, and Biological Effects” (VCH, New York, 1988); Luche, Ultrasonics 25, 40 (1987); Kitazume et al., J. Am. Chem. Soc. 107, 5186 (1985)).

Nanocomposites have been shown to offer tremendous improvements in mechanical and physical properties at very low loading levels for a number of polymeric resins. These attributes can provide affordable performance and/or improved tailor-ability for many industrial applications. Going from the micro- to the nanoscale introduces some unique aspects: at the nanoscale, specific surface area is very high, resulting in an increased effect of interface at low filler volumes, and filler size is approaching the scale of the polymer chain. Nanocomposites have often shown unexpected property improvements in many aspects.

Developing a reliable and economic method for production of nanocomposite materials is becoming a major challenge. Many approaches have been tried, and they are listed as follows:

1. The vapor deposition techniques, Akamatsu et al., Nanostructured Materials, 8, 1121 (1997) including chemical vapor deposition (CVP) or physical vapor deposition (PVD).

2. Precursor techniques, Watkins et al., Polym Mater. Sci. Eng., 73, 158 (1995) mainly belong to sol-gel types of chemistry. The precursors of nanoparticles (e.g. alkoxides of Si or other metals), often are first introduced in a pre-polymeric/polymeric matrix, then nanoparticles are generated in this matrix through appropriate chemical reactions.

3. Micelle or inverse micelle techniques, Mayer et al., Colloid Polym Sci, 276, 769 (1998); Chemical & Engineering News, 25-27, Jun. 7, 1999) where the precursors of nanoparticles are introduced into nanoscale domains, such as micelles or inverse micelles, resulting from the amphiphatic block or graft polymer, and particles form in situ through appropriate chemical reactions, such as reduction, The size of the particles is limited by the size of nanoscale domains.

4. Intercalation/Exfoliation of nano-platelets (such as nanoclay) into polymeric matrix, Qiao et al., Acta Polymer (China), 3, 135 (1995).

5. Super-molecule self-assembly technique, Weller, Adv Mater, 5(2), 193 (1993) by a complicated self-assembly process, the nanoscale super-molecular structure of fiber, layer, or tube can be produced.

6. Encapsulating polymerization, Bourgeat-Lami et al, Polymer, 36(23), 4385 (1995), where nanoparticles are first dispersed into a prepolymeric/polymeric matrix, then, under proper conditions, the polymerization of monomer occurs on the surface of nanoparticles, forming polymer layer encapsulating particles.

7. Nanoparticle surface initiated polymerization, Sugimoto, “Fine Particles”, 626-646 Marcel Dekker, Inc. New York, Basel (2000). This approach involves “growing” polymers directly from surfaces of nanoparticles. The general technique of this approach is to attach a convenient organic functionality to the particle. Nanocomposites can be produced through standard organic transformation reactions, such as polymerization.

Methods 6. and 7. appear to be two of the most promising approaches because of their diversified raw material sources, simple and adaptable production process, and high tailoring capability for a variety of industrial applications.

The method in the present invention is believed to belong to method 7.

The incorporation of nanoparticles into an immiscible (in many cases, organic) matrix represents one of the most difficult problems in the fabrication of nanocomposites. The success in the manufacturing of such materials can be achieved only if the aggregation of particles is avoided, and the nanoparticles are distributed in the matrix homogeneously.

Ultrasonic energy has been used to disperse one liquid metallic component in a second immiscible liquid metal, thereby producing a metallic emulsion. Upon lowering the temperature of this emulsion below the melting point of the lowest-melting constituent, a metal/metal-matrix composite is formed (Keppens et al.,“Nanophase and Nanocoposite Materials II Materials Research Society Symposium Proceedings”, 457, 243-248 (1997). No real chemistry takes place in the process.

Ultrafine amorphous Si/C/N powders are obtained using ultrasonic injection of a liquid precursor (hexamethyldisilazane: HMDS) into the beam of a high power industrial cw-CO₂ laser (Herlin et al., Journal of the European Ceramic Society, 13(4), 285-291 (1994).

Chinese patent 1280993 and a published article by the same authors (Wang et al., C. Journal of Applied Polymer Science, 80(9), 1478-1488 (2001) reported that ultrasound induced encapsulating emulsion polymerization was first used to prepare the novel polymer/inorganic nanoparticles composites. Here, ultrasound and both cationic and anionic surfactants were used for emulsion preparation. The activation behavior of nanoparticles in the aqueous solution under ultrasonic irradiation was also reported. More interestingly, they have reported the successful ultrasound induced emulsion polymerization of n-butyl acrylate (BA) and methyl methacrylate (MMA) without any chemical initiator. However, a suspicion resulted from their experimental section that the acrylate solution/emulsion was deoxygenated. Therefore, emulsion polymerization of the monomers might be simply caused by the removal of oxygen-inhibition and heat generated by ultrasonic irradiation.

Nano-sized materials have at least one linear dimension having a mean size between 0.1 and 250 nm. Preferably, the mean size is less than 100 nm. Nano-sized materials exist with the nano-size in three dimensions (nano-particles), two dimensions (nano-tubes having a nano sized cross section, but indeterminate length) or one dimension (nano-layers having a nano-sized thickness, but indeterminate area). Preferred aspects of the present invention relate to nano-sized materials comprising nanoparticles.

Nano-sized materials (II) are generally of mineral nature. They can comprise aluminum, oxide, silica, etc.

Published prior art WO 00/69392 describes transparent or translucent photopolymerizable composites for dental and medical restoration. The composites contain zirconium oxide nanoparticles whose surface is functionalized with a coupling agent which is preferably zirconate. The photopolymerizable composite is formed by mixing a solution of nanoparticles with a solution of a suitable matrix monomers and photoinitiator. There is no dispersion step of the nanoparticles using ultrasound irradiation.

### SUMMARY OF THE INVENTION

An objective of this invention is to combine ultrasonic irradiation and nanoparticle surface modification to provide a more efficient and effective method for producing nanocomposite, particularly, organic-inorganic hybrid nanocomposite materials. This combination provides multiple process-functions including dispersing particles into organic media, crushing/pulverizing particles to desired nano-scale, and freshening (cleaning) the surface of nanoparticles for the following surface modification reactions. More importantly, through microjets and/or shock waves, ultrasonic irradiation diffuses bulky surface modifying agents onto nanoparticle surfaces, and also possibly, activates/accelerates surface modification reactions due to effects of “local hot spot” mentioned above. Under ultrasonic irradiation, particle crushing/pulverizing with simultaneous surface modification effectively prevents re-agglomeration of nanoparticles. Lack of any one of above two process-elements will cause either re-agglomeration or inhomogeneous nanocomposites.

Another objective of the invention is to allow one to use cheap, powder form nanoparticles as raw materials for nanocomposite production. Many nanoparticle product suppliers provide powder form “nanoparticle” products, in which their actual particle size are actually several or tens of microns due to re-agglomeration. The suppliers claim that the primary particle size of their products is smaller than 100 nm. Colloidal types of nanoparticle products usually have a much more controllable particle size and particle size distribution. However, the prices of these products are much higher.

The third objective of the invention is to provide a method to make hybrid nanocomposite materials that can be, preferably, radiation (e.g., UV/electron beam) curable, and also thermally curable.

Another objective of the invention is to provide a method to make hybrid nanocomposites, in which inorganic nanophases are covalently bonded with organic networks.

Another objective of the invention is to provide a method to make hybrid nanocomposites with extremely high homogeneity with a single and narrow particle-size distribution peak in the nano-scale.

Another objective of the invention is to provide a method to make hybrid nanocomposite materials with better rheological behavior, therefore, better processability than those hybrid nanocomposite materials prepared without ultrasonic treatment and/or without surface modification.

Another objective of the invention is to provide a method to make hybrid nanocomposite materials that form cured coatings/films with better surface hardness than those formed solely from base-resins or traditional filler systems.

Another objective of the invention is to provide a method to make hybrid nanocomposite materials that form cured coatings/films with better surface scratch resistance than those formed solely from base-resins or traditional filler systems.

Another objective of the invention is to provide a method to make hybrid nanocomposite materials that form cured coatings/films with higher abrasion resistance than those formed solely from base-resins or traditional filler systems.

Another objective of the invention is to provide a method to make hybrid nanocomposite materials that form cured coatings/films with better solvent/chemical resistance than those formed solely from base-resins or traditional filler systems.

Another objective of the invention is to provide a method to make hybrid nanocomposite materials that form cured coatings/films with higher impact resistance than those formed solely from base-resins or traditional filler systems.

Another objective of the invention is to provide a method to make hybrid nanocomposite materials that form cured coatings/films with higher storage modulus than those formed solely from base-resins or traditional filler systems.

Another objective of the invention is to provide a method to make hybrid nanocomposite materials that form cured coatings/films with higher loss modulus than those formed solely from base-resins or traditional filler systems.

Another objective of the invention is to provide a method to make hybrid nanocomposite materials that form cured coatings/films with more controllable Tg (glass transition temperature) than those formed solely from base-resins or traditional filler systems.

Another objective of the invention is to provide hybrid nanocomposite materials that form cured coatings/films with better weather-ability than those formed solely from base-resins or traditional filler systems.

The present invention seeks to achieve these objectives by fabricating nanocomposite, particularly, organic-inorganic hybrid nanocomposite materials.

More specifically, the present invention provides a method for producing organic/inorganic hybrid nanocomposites which comprises:

a. subjecting a dispersion with inorganic particles to ultrasonic agitation to produce a dispersion of nanosized inorganic particles, and

b. reacting the nanosized inorganic particles from step a. with an organic coupling agent to modify the surface of said particles to inhibit agglomeration of said particles.

### DETAILED DESCRIPTION OF THE INVENTION

The present method produces the nanoparticle composites by ultrasonic agitation alone or in combination with mechanical agitation.

The mechanical agitation and ultrasonic agitation may be performed sequentially or simultaneously.

Suitable inorganic particles include alumina, other metal oxides, silica, carbon, metals, etc.

Suitable organic coupling agents include organozirconates, organotitanates and organosilanes. Neopentyl (diallyl)oxy triacryl zirconate) is an example.

Additionally, there may be employed an adhesion promotor and suitable adhesion promotors include 3-methacryloxytrimethoxysilane, 3-glycidoxypropyltrimethoxysilane and other organosilanes.

Further, the instant hybrid nanocomposites are suitable for use in radiation curable compositions comprising the nanocomposite and the radiation curable resin.

Suitable radiation curable resins include at least one of the three following reactive components:

1) one or more radiation polymerizable reactive oligomers or prepolymers, the molecular weight of which is generally lower than 10,000 and which have, at the chains ends or laterally along the chain, acrylic, methacrylic, vinyl or allyl groups.

2) one or more polyethylenically unsaturated reactive monomers which contain at least two ethylenically unsaturated groups. These reactive monomers are preferably diacrylates or polyacrylates of polyols of low molecular weight. The essential role of these reactive monomers is to enable adjustment of the viscosity depending on the intended industrial application.

3) one or more monoethylenically unsaturated reactive monomers which contain only one ethylenically unsaturated group per molecule. Examples of such monomers are the monoacrylates or monomethacrylates of monohydric or polyhydric aliphatic alcohols. Other examples of such monomers are styrene, vinyltoluene, vinylacetate, N-vinyl-2-pyrrolidone, N-vinylpyridine, N-vinylcarbazole, and the like. These monomers are added to the compositions as reactive diluents in order to lower the viscosity. These monomers can also have a considerable influence on the physical and chemical properties of the final coatings obtained. The reactive monomers used in the radiation curable compositions should have the following properties:

low toxicity

low volatility and odor

low viscosity

high reactivity.

However, current commercially available monomer systems fail to completely fulfill these prerequisites at the same time. Compromise must be made since in general, with these systems,

the lower the viscosity of the monomer, the lower reactivity of the formulation at a given monomer content and

the lower the viscosity of the monomer, the higher the volatility and the lower the human olfactory threshold.

Besides the above-mentioned reactive components, the radiation curable compositions may contain various auxiliary constituents to adapt them to their specific technical applications.

Optionally, a photoinitiator especially in combination with a tertiary amine is added to the composition so that, under the influence of ultraviolet irradiation, the photoinitiator produces free radicals which initiate the crosslinking (curing) of the composition. The photoinitiator is, for example, benzophenone, benzil dimethylketal, thioxanthones, and the like.

The proportions (ranges) of the foregoing materials are as follows:

Nanoparticles—1 to 30% by wt. of the total nanocomposite formulation.

Coupling agents—0.1 to 5.0% by wt. of the nanoparticles.

Radiation curable resins—60 to 95% by wt. of the total nanocomposite formulation.

Photoinitiators—1 to 6% by wt. of the total radiation curable resin composition.

Adhesion promoters 0.5 to 5% by wt. of the total nanocomposite formulation.

There will now be described examples of embodiments according to the present invention. These embodiments are merely exemplary and are not intended to limit the present invention in any manner.

### EXAMPLES

Equipment:

Ultrasonic Liquid Processor used in the invention was obtained from Sonic & Materials, Inc. The model is Vibra-Cell 130; it generates ultrasonic irradiation with the frequency of 20 kHz and the output power is 130 watts.

Materials:

1. Aluminum Oxide C, Al₂O₃ powder with average primary particle size (TEM) of 13 nm was obtained from Degussa-Huls. It was used as received.

2. MA-ST-S, silica nanoparticle dispersion in methanol with average primary particle size of 8-10 nm was obtained from Nissan Chemicals.

3. NZ-39, neopentyl (diallyl) oxy triacryl zirconate, was obtained from KenRich Petrochemicals Inc.

4. Z-6030, 3-methacryloxypropyltrimethoxysilane, was obtained from Dow Corning Corp. It was used as adhesion promoter.

5. Tabular Alumina, micron-sized alumina filler, was obtained from Alcoa Chemicals

6. Tripropylene Glycol Diacrylate(TRPGDA) Monomer was UCB Chemicals' tri-functional monomer. It was used as a part of the base resin.

7. Eb 8402 is UCB Chemicals' difunctional aliphatic urethane acrylate oligomer. It was used as a part of the base resin.

8. Eb 1290 is UCB Chemicals' six-functional aliphatic urethane acrylate oligomer. It was used as a part of the base resin.

9. Irgacure 184 was obtained from Ciba Inc. It was used as PI.

10. D.I. water was made in UCB Chemicals' Analytical Lab by using the NANOpure system from Barnstead/Thermarlyne Inc. The quality of D.I. water always meets the electronic resistance number of 18MΩ-cm.

Test Methods

1. DMA tests were performed on DMA 2980 (Dynamic Mechanical Analyzer) from TA Instruments. The tests provided data of storage modulus, loss modulus and Tg of the cured films.

2. Pencil Hardness ASTM D 3363—This test method covers a procedure for rapid determination of the film hardness of a coating on a substrate in terms of drawing leads of known hardness.

3. Abrasion Resistance of Organic Coatings by the Taber Abraser, ASTM D 4060-84—The coating is applied at uniform thickness to a Leneta chart, and, after curing, the surface is abraded by rotating CS-17, 500 g weighted wheels. Coatings are subjected to 50 or more cycle intervals of abrading. If after the 50-cycle interval, there is any sign of breakthrough to the substrate, the testing is terminated. Loss in weight at each 50-cycle interval is also calculated.

4. Scratch Resistance The test panel is held firmly in one position and a 4″×4″ eight layered square of steel wool (˜1 cm thick), covering a two pound ball peen hammer is rubbed back and forth across the coating, counting each back and forth motion as one double rub. The handle of the hammer is held in as close to a horizontal position as possible and no downward pressure is exerted on the hammer. At the first sign of scratching, haze, or breakthrough to the substrate, the counting and test are terminated.

5. Impact Resistance Procedure is the same as ASTM D 2794

6. MEK Resistance (Chemical Resistance by Solvent Rub)—SMT 160-K (UCB Chemicals' test method) The test panel is held firmly in one position and a 4″×4″ eight layered square of cheese cloth, covering a two pound ball peen hammer is soaked with MEK, and the hammer is rubbed back and forth across the coating, countings each back and forth motion as one MEK double rub. The handle of the hammer is held in as close to a horizontal position as possible and no downward pressure is exerted on the hammer. At the first sign of breakthrough to the substrate, the counting and test are terminated.

7. Adhesion ASTM D 3359-95A (Measuring Adhesion by Tape Test)—An area free of blemishes and minor surface imperfections is selected. Two cuts are made in the film, using a multi-tip cutter for coated surfaces. The coated substrate is placed on a firm base, and parallel cuts are made. All cuts are about ¾ in. (20 mm) long. The film is cut through to the substrate in one steady motion using just sufficient pressure on the cutting tool to have the cutting edge reach the substrate. After making the required cuts, the film is lightly brushed with a tissue or soft brush to remove any detached flakes or ribbons of coatings. The cut areas are then covered with one-inch wide semitransparent pressure-sensitive tape. The tape is then removed and discarded. The areas are then brushed and inspected for percent of area removed: 5B=0%, 4B=Less than 5%, 3B=5-15%, 2B=15-35%, 1B=35-65%, OB=Greater than 65%.

8. Cylindrical Mandrel Bend Tests A conical mandrel test consists of manually bending a coated metal panel over a cone. As described in ASTM Test Method for Elongation of Attached Organic Coatings with Conical Mandrel Apparatus (D 522), a conical mandrel tester consists of a metal cone, a rotation panel bending arm, and panel clamps. These items are all mounted on a metal base. The cone is smooth steel 8 in. in length with a diameter of ⅛ in. at one end and a diameter of 1.5 in. at the other end. When a coating is applied on a 1/32-in.-thick cold-rolled steel panel, as specified in ASTM S 522, a bend over the mandrel produces an elongation of 3% at the large end of the cone and of 30% at the small end of the cone. The coated panel is bent 135° around the cone in approximately 1 second to obtain a crack resistance rating under simulated abuse conditions. In this study, the length of cracking was then measured and reported.

9. Particle Size and Particle Size Distribution Analysis Nanoparticle samples were analyzed using a Coulter LS230 Particle Size Analyzer. This instrument uses laser light scattering to detect particles in the range of 0.04 to 2,000 micrometers. Samples were fully dispersed in methanol after shaking for three minutes. Particle size data was collected and averaged over 90 seconds for each run. The size calibration of the method was checked using reference standards at 15 and 55 micrometers

Control Samples:

For comparison purposes, three control-samples were made in this invention. Their compositions are listed in the Table 1. The performance comparison of the invented nanocomposites with these control samples are listed the Tables 3, 4, and 5. The photoinitiator levels in every formulation of both control-samples and nanocomposites are always 4% of UV-resin weight. The procedures for preparation of films/coatings of the control-samples, the cure conditions for these control samples, and the property test methods are all the same as that for the invented nanocomposite samples described below.

TABLE 1

| | Mixture of UV- | | | | Traditional Filler | |
|---|---|---|---|---|---|---|
| | Resins as Control | | Neat UV-Resin as | | System | |
| Composition | sample I | Parts | Control sample II | Parts | Control sample III | Parts |
| Particles | No | | No | | Micro size Al₂O₃ | 10 |
| Surface Modifying | No | | No | | No | |
| Agents | | | | | | |
| Adhesion promoter | No | | No | | No | |
| Organic Base | Eb 8402/TRPGDA | 100 | Eb 1290 | 100 | Eb 8402/TRPGDA | 90 |
| Resins | (50/50) | | | | (50/50) | |
| Photoinitiator | Irgacure 184 | 4 | Irgacure 184 | 4 | Irgacure 184 | 3.60 |
| Total | | 104 | | 104 | | 103.60 |
| Corresponding | | | | | | |
| Reaction | | | | | | |

### Example 1

The first example, RX 05505, shows preparation of nanocomposite via the combination of ultrasonic irradiation and surface modification/functionalization of nanoparticles. KenRich Petrochemicals Inc provides neoalky zirconate (titanate and etc.), chelated titanate (or zirconate and etc.), monoalkoxy titanate (or zirconate and etc.) as some examples of coupling agents. Typically, NZ 39, named neopentyl (diallyl) oxy triacryl zirconate was employed in this example. By using this coupling agent, nanoparticle surface modification provides, in addition to better compatibility between inorganic and organic matrix, polymerizable/crosslink-able reactivity, preferably, UV curable functionality. The molecular structure of this coupling agent is represented as follows.

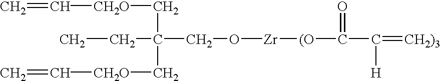

The composition of this nanocomposite is shown in Column 1 in Table 2

TABLE 2

| | EXAMPLE 1 | | EXAMPLE 2 | | EXAMPLE 3 | |
|---|---|---|---|---|---|---|
| Composition | Nanocomposite(I) | Parts | Nanocomposite(II) | Parts | Nanocomposite(III) | Parts |
| Particles | Al₂O₃ | 10.0 | Al₂O₃ | 4.32 | SiO₂ | 10.0 |
| | | | SiO₂ | 1.08 | | |
| Surface Modifying | NZ-39 | 0.05 | NZ-39 | 0.05 | NZ-39 | 0.05 |
| Agents | | | | | | |
| Adhesion promoter | Z-6030 | 0.48 | | 0.0 | Z-603 | 1.03 |
| Catalyst | | | | 0.0 | Acrylic acid | 1.00 |
| D.I. Water | | | | 0.0 | H₂O | 0.24 |
| Organic Base Resins | Eb 8402/TRPGDA | 91.03 | Eb 8402/TRPGDA | 94.53 | Eb 1290 | 88.9 |
| | (50/50) | | (50/50) | | | |
| Photoinitiator | Irgacure 184 | 3.64 | Irgacure 184 | 3.78 | Irgacure 184 | 4.0 |
| Total | | 99.99 | | 103.78 | | 105.22 |
| Corresponding | RX 05505 | | RX 01399 | | RX 05596 | |
| Reaction | | | | | | |

The Al₂O₃ nanoparticles (Alumina C) in powder form was first mechanically dispersed into methanol by stirring with magnetic bar. The ratio of Al₂O₃ to methanol was about 1/20-1/50. A milk white dispersion was obtained after two hours of agitation.

The stability of this dispersion (Sample 1) was poor. Precipitation was seen 10-15 minutes after the agitation was stopped. With only mechanical agitation, the alumina particles could only reach 15-20 microns on average.

Therefore, the combination of mechanical agitation and ultrasonic irradiation was employed as per the present invention. One hour of ultrasonic irradiation and mechanical agitation effectively crushed and pulverized agglomerated alumina C particles to nano-scale (121 nm in average). The new dispersion (Sample 2) shows much better stability than Sample 1. However, the dispersed nanoparticles still could re-agglomerate, and the precipitation was seen after setting at room temperature for 1-2 days (see Sample 2). It is worthy to note that the precipitates at the bottom of Sample 2 are much less than that of Sample 1.

Furthermore, the surface of the nanoparticles was protected by surface-modification in the present invention.

A coupling agent, NZ-39, was dissolved in methanol to make 1-5% solution. At room temperature, the solution was then drop-wise added into the dispersion under conditions of a combination of ultrasonic irradiation and mechanical agitation. The amount of surface modifying agent used in the reaction depends on the reactivity of the coupling agent, the molecular size of the coupling agent, the type and size of the particles, the surface structure of the particles, as well as the available number of reactive groups on the surface of the nanoparticles. In this example, the amount of NZ-39, based on the particles (Aluminum Oxide in this case) weight, can be varied from 0.1-5.0%. The surface modification reaction normally takes place at room temperature. However, in order to ensure completion of the reaction, the mixture should be refluxed at 60° C. for two hours.

After surface modification, the Aluminum Oxide dispersion was very stable. Organic molecule attachments on the surface of nanoparticles normally cause an increase in nanoparticle size. However, the size distribution peak of the modified nanoparticles is narrower, and the average of the particle size is even smaller: 118 nm. This fact strongly indicates that under ultrasonic irradiation, simultaneous surface modification is significantly helpful in the crushing/pulverizing particle process.

A more interesting phenomenon was seen: the surface modified Alumina C particles became much more hydrophobic, and therefore, less compatible with hydrophilic methanol. The dispersion showed two organic layers, but no precipitation at the bottom of the container (Sample 3). As a hydrophobic solvent, such as toluene, was added into the dispersion with simple shaking, the two layers disappeared, and a stable dispersion was obtained (Sample 4). There was no precipitation after setting at room temperature for at least two months.

Then, the dispersion (Sample 3) was easily and homogeneously mixed with organic resins, preferably, UV-curable resins in the present invention. In this example, the mixture of Eb8402/TRPGDA with 50/50 ratio was used as the base resin. The composite material normally contains 1.0%-10%, but possibly high as 40% by weight of modified nanoparticles based on the total formulation weight. The solvent, methanol, contained in the material was evaporated at 40° C. with gradually increased vacuum values of the system from 240 millibar to 50 millibar. Through this “solvent exchange” operation, at least 97%, and more often, 100% of the methanol could be evaporated. Therefore, the nanocomposite material becomes 100% reactive. More clearly, the inventive nanocomposites contain both organic resins and modified nanoparticles, which are reactive, and preferably, UV-curable.

4 parts of photoinitiator (Irgacure 184 in the present invention), based on weight of UV-curable materials, was homogeneously mixed into the produced nanocomposite materials to form the final formulation.

The produced liquid nanocomposite material is very stable after 10 months no precipitation or significant viscosity changes have been seen.

### Example 2

Following the procedures described in Example 1, with one change, produced another nanocomposite, RX 01399. The composition of this nanocomposite is listed in Column 2 of Table 2. Instead of solely using Al₂O₃ nanoparticles as in Example 1, the combination of Al₂O₃ and SiO₂ nanoparticles were employed.

Again, the produced nanocomposite material was stable for at least 10 months without seeing precipitation or significant viscosity changes.

Approximately 0.5-6 mil films/coatings) were drawn down on Parker Bonderite 40 steel panels. The thickness of coatings/films depend on the # of the drawing bar and the viscosity of the materials. The panels then were cured in air using one or two 300 watt/inch mercury vapor electrodeless lamps, at the maximum belt speed that gave tack-free (cured) films/coatings.

The properties of these films/coatings were then tested according to the methods described above.

The property data listed in Table 3 clearly indicate the advantages of the invented nanocomposite.

In comparison to UV-resins, the traditional filler system has shown some improvements in MEK resistance, abrasion resistance and Tg. However, under production conditions, the phase separation between inorganic and organic phases in these systems has been always a big problem for long time. Also because of this problem, the material property can only be tailored in a very narrow range.

The nanocomposite shows surface performance improvements in every category except adhesion and impact resistance. The poor adhesion is believed due to lack of reactive hydroxyl groups (for interaction with substrate surface) in this material.

DMA tests also indicate that the loss and storage modulus and Tg of the nanocomposite are all improved. Moreover, the variation in multi-parallel DMA test results is much smaller for the invented nanocomposites than for those composite samples without ultrasonic treatments or for those composite samples without surface modification. This implies higher homogeneity in the invented nanocomposite. It is believed that this improvement is closely related to smaller nanoparticle size, the narrower distribution of nanoparticle size, and homogeneously diffusing nanoparticles in the nanocomposites.

TABLE 3

| | | | |
|---|---|---|---|
| PROPERTY | Mixture of UV-Resins as | Traditional Filler System | Nanocomposite (II) |
| | Control Sample | | With Al₂O₃ and SiO₂ |
| APPEARANCE | Newtonian liquid | Phase Separation | Viscous liquid, |
| | | | pseudo-plastic |
| UV-DOSAGE (J/cm²) | 2.8-3.5 | 2.8-3.5 | 2.8-3.5 |
| SURFACE PENCIL | 5-6H | 5-6H | 9H |
| HARDNESS | | | |
| MEK RESISTANCE | 70-110 | 90-110 | 170-190 |
| ABRASION | 50 cycles failed | 100 cycles failed | 100 cycles failed |
| RESISTANCE | | | |
| IMPACT RESISTANCE | 50-70 | 42-44 | 60-70 |
| | lb.-inch | | |
| ADHESION ON STEEL | 3B | 0B | 1B |
| PANEL | | | |
| Tg (Loss Mod.) | 34° C. | 48° C. | 51° C. |
| Storage Modulus | 1336 (MPa) | 1716 (MPa) | 2105 (MPa) |
| (@ 25° C.) | | | |
| Loss Modulus | 147 (MPa) | 181 (MPa) | 173 (MPa) |
| (@ Tg) | | | |

### Example 3

Following the preparation procedures described in Example 1 and 2 another nanocomposite was prepared. The composition is listed in Column 3 of Table 2.

Eb 1290 was used as the base resin in this example. Eb 1290 is UCB Chemicals' six-functional aliphatic urethane acrylate oligomer, which provides greater than 9H surface hardness and very good surface scratch resistance. However, it is extremely brittle. The purpose of making this nanocomposite is to increase the flexibility without loss of other advantages of Eb 1290, such as hardness and scratch resistance.

A small amount of silane, Z-6030, was added for adhesion promotion. At the same time, a very small amount of acrylic acid was added as the catalyst for hydrolysis and condensation reactions, and an equivalent amount of water was added for hydrolysis reaction of the silane.

The performance data of the nanocomposite in Table 4 indicate improvements in flexibility reflected as impact resistance and conical bend. Note that, adhesion is also increased.

More dramatically, abrasion resistance of the invented nanocomposite increases greatly from 100 cycles to greater than 20,000 cycles without failure. At the same time, the advantages of Eb 1290 remain.

TABLE 4

| | | |
|---|---|---|
| PROPERTY | Neat UV-Resin | Nanocomposite (III) |
| | as Control sample II | With SiO₂ and Silane |
| APPEARANCE | Newtonian, viscous | Viscous liquid, |
| | liquid at 60° C. | pseudo-plastic at 25° C. |
| UV-DOSAGE | 0.6 | 0.6 |
| (J/cm²) | | |
| SURFACE PENCIL | >9H | >9H |
| HARDNESS | | |
| MEK | >200 | >200 |
| RESISTANCE | | |
| ABRASION | 100 cycles | 20,000 cycles |
| RESISTANCE | failed | without failure |
| SCRATCH | >200 | >200 |
| RESISTANCE | | |
| (steel Wool | | |
| double rubs) | | |
| IMPACT | 8 | 16 |
| RESISTANCE | | |
| lb.-inch | | |
| ADHESION ON | 3B | 4B-5B |
| STEEL PANEL | | |
| Conical Bend | 0 inch failed | 4 inch failed |

Table 5 presents more details regarding improvements of abrasion resistance. In addition, the weight lost per abrading cycle for the invented nanocomposite significantly decreases.

TABLE 5

| | CS-17 Test Results (failed-broken through, weight lost: | | | |
|---|---|---|---|---|
| Sample | μg/cycle) Coating thickness: ˜0.5 mil. | | | |
| Control Sample | 100 cycles, | | | |
| Eb 1290 | Failed, | | | |
| | 66.0 | | | |
| RX 05596 | 100 cycles, | 1,000 cycles, | 10,000 | 20,000 |
| | Passed, | Passed, | cycles, | cycles, |
| | 0.0 | 3.6 | Passed, 2.2 | Passed, 2.0 |

I claim:

1. A method for producing an organic/inorganic hybrid nanocomposite which comprises:
a. subjecting a dispersion of inorganic particles to ultrasonic agitation to produce a dispersion of nanosized inorganic particles having at least one linear dimension having a mean size between 0.1 and 250 nm; and
b. reacting the nanosized inorganic particles from step a. with an organic coupling agent to modify the surface of said particles to inhibit agglomeration of said particles.

2. The method according to claim 1 wherein the particles of step a. are subjected to both ultrasonic and mechanical agitation.

3. The method according to claim 1 wherein ultrasonic and mechanical agitation are performed simultaneously.

4. The method according to claim 1 wherein ultrasonic and mechanical agitation are performed sequentially.

5. The method according to claim 1 wherein the inorganic particles are at least one of metals, metal oxides, carbon and silica.

6. The method according to claim 1 wherein the coupling agent is at least one of organosilanes, organotitanates and organozirconates.

7. The method according to claim 1 wherein an adhesion promoter is additionally employed in step b.

8. The method according to claim 7 wherein the adhesion promoter is additionally employed in step b.

9. The hybrid nanocomposite produced according to claim 1.

10. A radiation curable composition comprising the hybrid nanocomposite according to claim 9 and a radiation-curable resin.

11. The radiation curable composition according to claim 10 additionally comprising a photoinitiator.
